(19) United States
(12) Patent Application Publication
(10) Pub. No.: US 2010/0078428 A1
(43) Pub. Date: Apr. 1, 2010

(54) MICROWAVABLE FOOD PACKAGE

(75) Inventors: Michael J. Schaefer, Evansville, IN (US); David O'Nan, Henderson, KY (US); Jason Paladino, Newburgh, IN (US); David J. Jochem, Evansville, IN (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/569,633

(22) Filed: Sep. 29, 2009

Related U.S. Application Data
(60) Provisional application No. 61/101,488, filed on Sep. 30, 2008.

(51) Int. Cl. H05B 6/80

(52) U.S. Cl. 219/730

(57) ABSTRACT

A microwavable food package includes a container and a closure coupled to the container to close an open cavity formed in the container. The container includes a susceptor used to absorb microwaves and convert the microwaves to heat to facilitate cooking certain foods in a microwave oven.

This application claims priority under 35 U.S.C. §119(e) to U.S. Provisional Application Ser. No. 61/101,488, filed Sep. 30, 2008, which is expressly incorporated by reference herein.

### BACKGROUND

The present disclosure relates to containers, and particularly to food containers. More particularly, the present disclosure relates to microwavable food containers that are used with frozen entrees.

### SUMMARY

In accordance with the present disclosure, a microwavable food package includes a framework and a sheet coupled to the framework. The package includes a basin that is formed to include an interior food-storage region.

In illustrative embodiments, the framework is made of a plastics material and is formed to include an endless rim and a basket arranged to depend from the endless rim and formed to include several openings. The sheet is coupled to the framework to close the several openings formed in the basket and cooperate with the framework to form a container having the basin defining the interior food-storage region. The sheet comprises a susceptor configured to provide means for absorbing electromagnetic energy generated in a microwave oven and converting it to heat that is applied to any food extant in the interior food-storage region and a heat-insulation shield interposed between and coupled to the framework and the susceptor to establish a heat-insulation buffer between the framework and the susceptor. In an illustrative embodiment, the heat-insulation shield is made of paperboard.

In illustrative embodiments, the sheet includes a floor and upstanding panels coupled to the floor. The basket includes a floor support coupled to a portion of the paperboard shield included in the floor of the sheet and at least three pillars arranged to interconnect the endless rim and the floor support to form the several openings therebetween. The pillars are coupled to a portion of the outer surface of the paperboard shield included in the upstanding panels of the sheet.

In illustrative embodiments, the framework has a generally rectangular shape and four corners and includes four pillars arranged to position each pillar at one of the four corners. The floor support extends under the floor of the sheet and includes a first strip arranged to interconnect two of the four pillars and a second strip coupled to the other two of the four pillars and the first strip. The paperboard shield included in the sheet is coupled to the endless rim, the four corners, and the first and second strips to close the several openings formed in the basket to form the basin in the container.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is an exploded perspective assembly view of a microwavable food package in accordance with the present disclosure showing an empty container formed to include an interior food-storage region and a closure adapted to mate with a rim of the container to close a top aperture opening into the interior food-storage region;

FIG. 2 is an inverted view of the assembled microwavable food package of FIG. 1 showing a framework made of a plastics material and coupled to an outer surface of a sheet shown in an unfolded state in FIG. 3 and folded along four fold lines as suggested in FIG. 7 to produce a floor, two end panels, and two side panels;

FIG. 3 is a top plan view of the sheet of FIGS. 1, 2, and 7 before it is folded as suggested in FIG. 7 and with portions broken away to reveal that the sheet is laminated and comprises three layers in an illustrative embodiment;

FIG. 4 is an enlarged sectional view taken along line 4-4 of FIG. 3 showing that the sheet is laminated and comprises a relatively thick heat-insulation shield (made in an illustrative embodiment of paperboard) and a multi-layer susceptor coupled to an inner surface of the paperboard heat-insulation shield and formed to include a top film layer and a metal layer interposed between the paperboard heat-insulation shield and the top film layer and configured to be heated to a high temperature when exposed to microwaves in a microwave oven;

FIG. 5 is a perspective view of the container of FIG. 1 with portions of the laminated sheet removed to show that the framework (when molded as shown, for example, in FIGS. 8-10) is formed to include an endless rim, four corner pillars, and a crisscross-shaped floor support coupled to the four corner pillars and arranged to lie under the floor of the sheet and mate with the paperboard heat-insulation shield included in the laminated sheet;

FIG. 6 is an enlarged sectional view of the container taken along line 6-6 of FIG. 1 with portions of the laminated sheet broken away to reveal the metal layer and paperboard heat-insulation shield located under the film layer;

FIG. 7 is a perspective view of a male lower mold portion of an injection mold system shown in FIGS. 8-10 along with a partly folded sheet of the type shown in FIG. 3 and suggesting that, once folded, the sheet is inverted and mounted on the male lower mold portion of the injection mold system;

FIGS. 8-10 illustrate a process in accordance with the present disclosure for overmolding a framework made of plastics material onto a folded sheet comprising a paperboard heat-insulation shield and a susceptor in a mold cavity formed in an injection mold to produce a container as shown in FIGS. 1 and 2;

FIG. 8 is a sectional view of an illustrative injection mold having a female upper mold portion and a male lower mold portion, here shown spaced apart in an opened position, suggesting movement of the sheet into a chamber formed in the female upper mold portion;

FIG. 9 is a view similar to FIG. 8 after the folded sheet has been deposited into the chamber in the upper mold portion and showing the upper and lower mold portions in a closed position to form a mold cavity containing the folded sheet and showing the folded sheet in a pre-injection position prior to injection of a plastics material into the mold cavity (in the manner shown in FIG. 10); and

FIG. 10 is a view similar to FIGS. 8 and 9 showing the upper and lower mold portions in a closed position after the mold cavity has been filled with plastics material injected into the mold cavity by a plastics material injector to cause the injected plastics material to mate with the paperboard heat-insulation shield included in the sheet to form a container of a microwavable food package shown, for example, in FIGS. 1 and 2.

### DETAILED DESCRIPTION

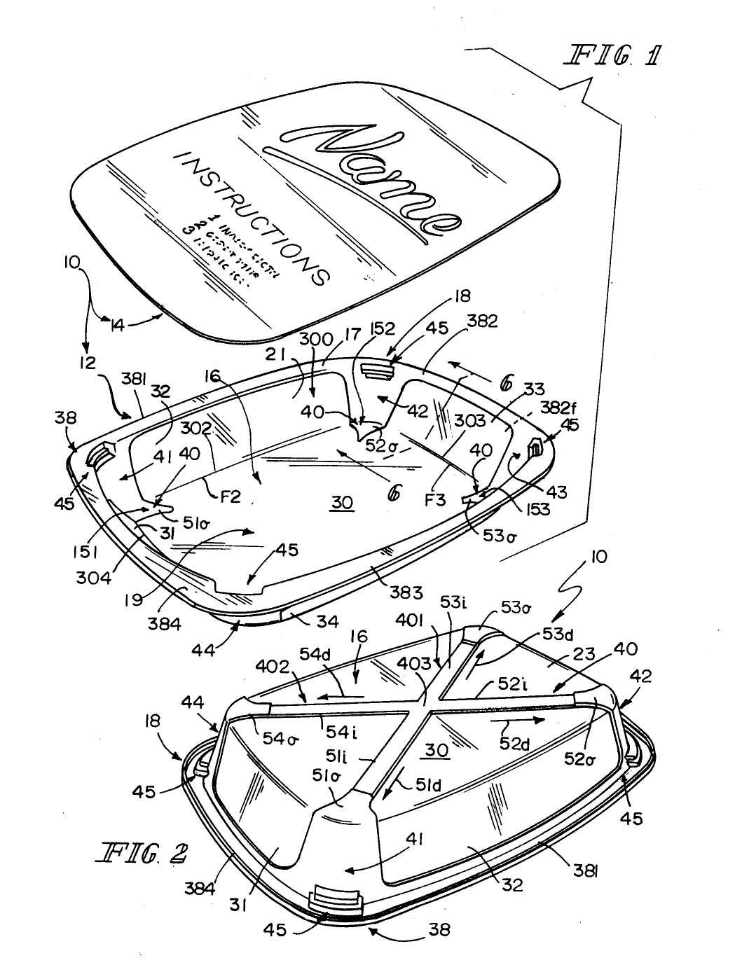

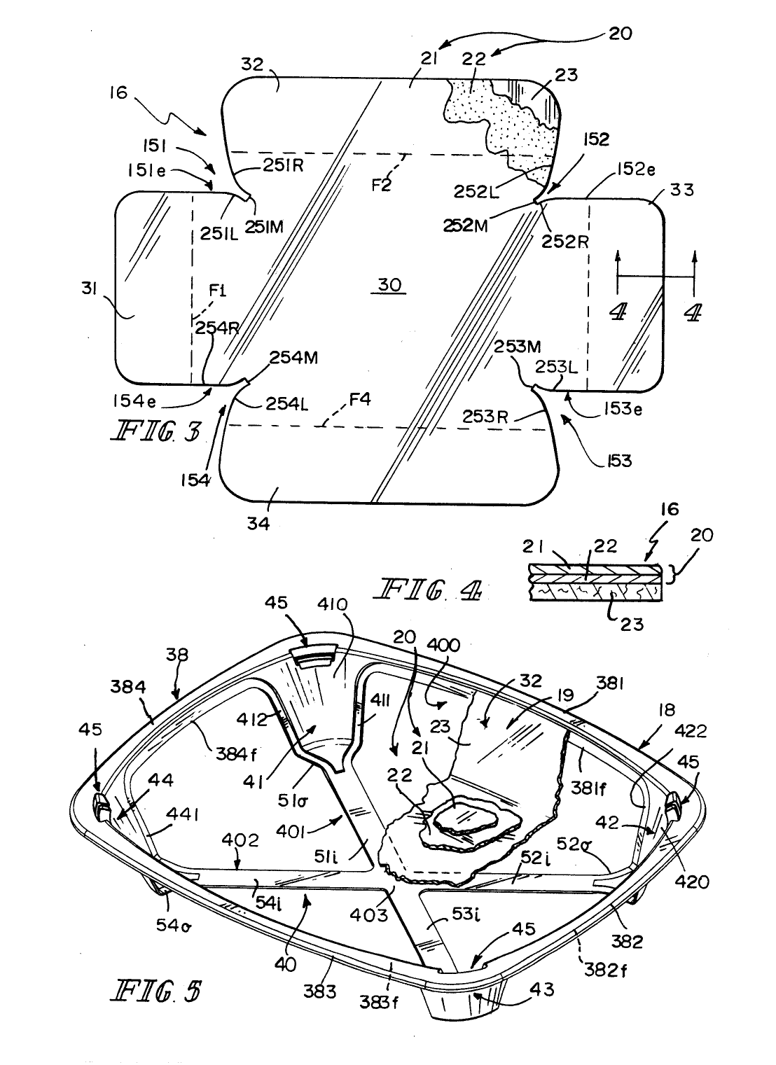

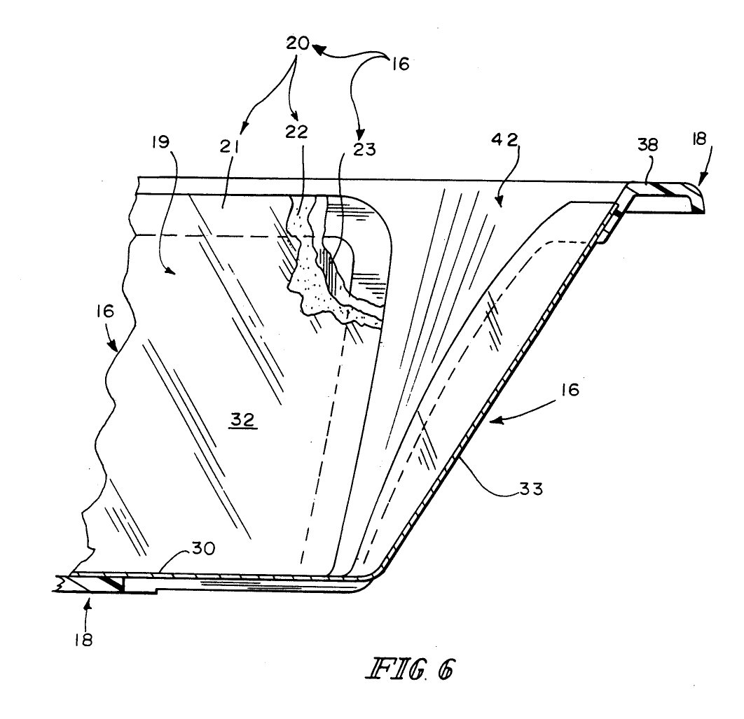

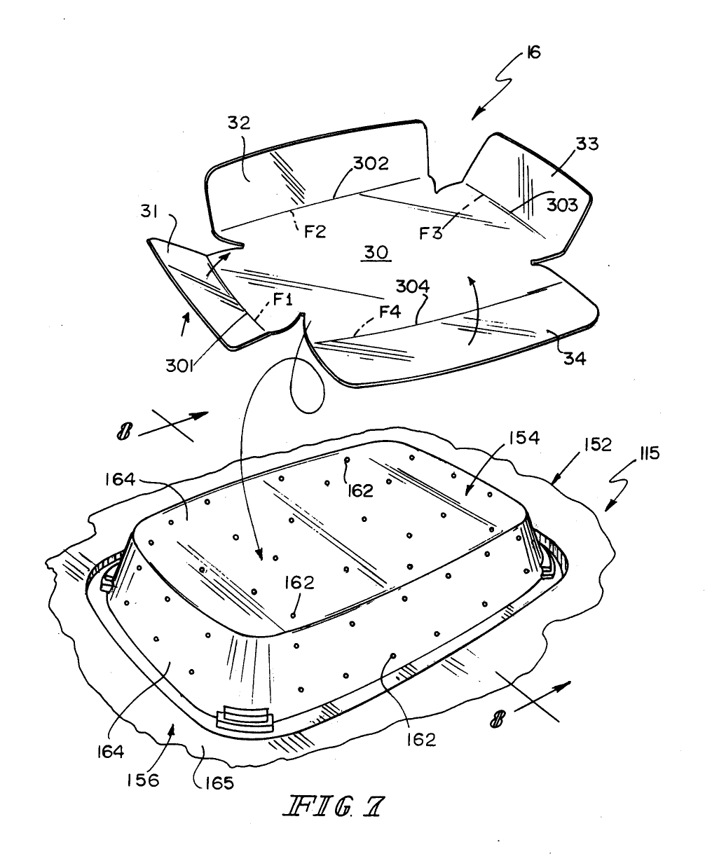

A microwavable food package 10 in accordance with the present disclosure includes a container 12 and a closure 14 as suggested in FIGS. 1 and 2. Container 12 includes a sheet 16 that is shown in FIGS. 3 and 4 and coupled to a framework 18 as suggested in FIGS. 1, 2, 5, and 6 to form an interior food-storage region 19 as suggested in FIGS. 1 and 5. Framework 18 is made of a plastics material and is overmolded onto sheet 16 after sheet 16 has been folded as suggested in FIG. 7 using an illustrative insert-molding process as suggested diagrammatically in FIGS. 8-10.

As suggested in an illustrative embodiment shown in FIGS. 3-5, sheet 16 includes a susceptor 20 comprising a top film layer 21 and an underlying metal layer 22. Sheet 16 also includes a heat-insulation shield 23. Framework 18 is coupled to heat-insulation shield 23 without contacting susceptor 20 as suggested, for example, in FIG. 5. Shield 23 is made of a heat-insulation buffer material and, in an illustrative embodiment, that material is paperboard.

Paperboard heat-insulation shield 23 is interposed between framework 18 and metal layer 22 of susceptor 20 as suggested in FIGS. 3-5 to cause paperboard heat-insulation shield 23 to provide a heat-insulation buffer between the framework 18 made of plastics material and metal layer 22 of susceptor 20. This buffer functions to minimize heat transfer between framework 18 and metal layer 22 when metal layer 22 of susceptor 20 is heated to assume a high temperature (e.g., about 500° F.) when exposed to electromagnetic energy generated in a microwave oven (not shown) used to cook food stored in interior food-storage region 19 of container 12.

Susceptor 20 is configured to provide means for absorbing electromagnetic energy generated in a microwave oven (not shown) and converting it to heat that is applied to any food extant in interior food-storage region 19 of container 12. Metal layer 22 is made of any suitable metal that assists in browning or crisping food being cooked in interior food-storage region 19. Metal layer 22 is illustratively vacuum-metalized aluminum. Paperboard heat-insulation shield 23 is arranged to separate susceptor 20, and in particular, metal layer 22 from the framework 18 made of a plastics material to shield framework 18 so that it does not melt or otherwise deform when metal layer 22 is heated to assume a high temperature in a microwave oven. Container 12 is rigidified by framework 18.

Container 12 is formed to include an interior food-storage region 19 and a top aperture 17 opening into interior food-storage region 19 as shown, for example, in FIG. 1. Closure 14 is coupled to framework 18 of container 12 to close top aperture 17 as suggested in FIG. 1. Closure 14 may be made of any suitable material such as film, foil, or cardstock and coupled to container 12 in any suitable manner.

Sheet 16 is a somewhat cross-shaped item in an illustrative embodiment shown in FIG. 3. Sheet 16 can be folded as suggested in FIG. 7 along fold lines F1-F4 to form a floor 30, a first end panel 31 coupled to floor 30 along a first fold line F1 established at a first end edge 301 of floor 30, a first side panel 32 coupled to floor 30 along a second fold line F2 established at a first side edge 302 of floor 30, a second end panel 33 coupled to floor 30 along a third fold line F3 established at a second end edge 303 of floor 30, and a second side panel 34 coupled to floor 30 along a fourth fold line F4 established at a second side edge 304 of floor 30. Each of floor 30 and panels 31-34 is a three-layer laminate as suggested in FIGS. 3 and 4 and includes a portion of top film layer 21, underlying metal layer 22, and paperboard heat-insulation shield 23.

Framework 18, once molded, using, for example, an insert-molding process shown diagrammatically in FIGS. 7 and 8-10, is shown in perspective in an inverted position in FIG. 2 and in an upright position in FIG. 5. Framework 18 is made of an injection molded plastics material (e.g., polyethylene or polypropylene) in an illustrative embodiment. Framework 18 provides package 10 with strength and rigidity as well as a surface for mating with closure 14.

In an illustrative embodiment, framework 18 has a generally rectangular shape and includes an endless rim 38, a floor support 40, a first corner pillar 41, a second corner pillar 42, a third corner pillar 43, and a fourth corner pillar 44 as suggested in FIGS. 2 and 5. Each corner pillar 41-44 is coupled to endless rim 38 and is arranged to extend downwardly to mate with floor support 40. In an illustrative embodiment shown in FIGS. 2 and 5, floor support 40 includes a first strip 401 arranged to interconnect first and third corner pillars 41, 43 and a second strip 402 coupled to first strip 401 at an intersection 403 and arranged to interconnect second and fourth corner pillars 42, 44. Framework 18 also includes an external stacking shoulder 45 coupled to rim 38 and to each pillar 41-44 as suggested in FIGS. 1 and 2.

First strip 401 of floor support 40 of framework 18 includes a first inner section 51i extending from intersection 403 toward first corner pillar 41 and a first outer section 510 interconnecting first inner section 51i and first corner pillar 41 as suggested in FIGS. 2 and 5. In the illustrated embodiment, first outer section 51o is bell-shaped and has a width that widens progressively in a direction 51d extending from intersection 403 toward first corner pillar 41 as suggested in FIGS. 2 and 5.

First strip 401 of floor support 40 of framework 18 includes a second inner section 53i extending from intersection 403 toward corner pillar 43 and a second outer section 53o interconnecting second inner section 53i and third corner pillar 43 as suggested in FIGS. 2 and 5. In the illustrated embodiment, second outer section 53o is bell-shaped and has a width that widens progressively in a direction 53d extending from intersection 403 toward third corner pillar 43 as suggested in FIGS. 2 and 5.

Second strip 402 of floor support 40 of framework 18 includes a first inner section 52i extending from intersection 403 toward second corner pillar 42 and a first outer section 52o interconnecting first inner section 52i and second corner pillar 42 as suggested in FIGS. 2 and 5. In the illustrated embodiment, first outer section 52o is bell-shaped and has a width that widens progressively in a direction 52d extending from intersection 403 toward second corner pillar 42 as suggested in FIGS. 2 and 5.

Second strip 402 of floor support 40 of framework 18 includes a second inner section 54i extending from intersection 403 toward fourth corner pillar 44 and a second outer section 54o interconnecting second inner section 54i and fourth corner pillar 44 as suggested in FIGS. 2 and 5. In the illustrated embodiment, second outer section 54o is bell-shaped and has a width that widens progressively in a direction 54d extending from intersection 403 toward fourth corner pillar 44 as suggested in FIGS. 2 and 5.

Rim 38 of framework 18 is coupled to each of the first end panel 31, first side panel 32, second end panel 33, and second side panel 34 as suggested in FIGS. 1 and 2. First corner pillar 41 is interposed between and mated with first end panel 31 and first side panel 32 as suggested in FIG. 1. Second corner pillar 42 is interposed between and mated with first side panel 32 and second end panel 33 as suggested in FIG. 1. Third corner pillar 43 is interposed between and mated with second end panel 33 and second side panel 34 as suggested in FIGS. 1 and 2. Fourth corner pillar 44 is interposed between and mated with second side panel 34 and first end panel 31 as suggested in FIG. 2.

Floor 30 of sheet 16 is formed to include a first pillar notch 151 defined by a bell-shaped concave edge 151e as suggested in FIG. 3. Bell-shaped concave edge 151e interconnects first end edge 301 and first side edge 302 and borders bell-shaped first outer section 510 of first strip 401 of floor support 40 to expose an upwardly facing portion of bell-shaped first outer section 51o to any food extant in interior food-storage region 19 formed in container 12 as suggested in FIG. 1. Bell-shaped concave edge 151e includes a middle segment 251M arranged to face toward first corner pillar 41, first (left) convex segment 251L bowed outwardly toward first side panel 32 and arranged to interconnect middle segment 251M and first fold line F1, and a second (right) convex segment 251R bowed outwardly toward first convex segment 251L and arranged to interconnect middle segment 251M and second fold line F2 as suggested in FIG. 3.

First pillar notch 151 is arranged to open toward first corner pillar 41 and a portion of floor support 40 is located in first pillar notch 151 so as to be visible to an observer looking into interior food-storage region 19 through top aperture 17 and arranged to define a boundary of interior food-storage region 19 formed in container 12 as suggested in FIG. 1. An upwardly facing surface of the portion of floor support 40 that is located in first pillar notch 151 is arranged to lie in substantially coplanar relation to film layer 21 of susceptor 20 as also suggested in FIG. 1.

Floor 30 of sheet 16 is also formed to include second, third, and fourth pillar notches 152, 153, and 154 in an illustrative embodiment as shown in FIG. 3. Each of these notches 152, 153, 154 is similar in shape and function to first pillar notch 151.

Second pillar notch 152 is defined by a bell-shaped concave edge 152e as shown, for example, in FIG. 3. Bell-shaped concave edge 152e interconnects first side edge 302 and second end edge 303 and borders a bell-shaped first outer section 52o of second strip 402 of floor support 40 to expose an upwardly facing portion of bell-shaped first outer section 52o to any food extant in interior food-storage region 19 formed in container 12 as suggested in FIG. 1. Bell-shaped concave edge 152e includes a middle segment 252M arranged to face toward second corner pillar 42, a first (left) convex segment 252L bowed outwardly toward second end panel 33 and arranged to interconnect middle segment 252M and second fold line F2, and a second (right) convex segment 252R bowed outwardly toward first convex segment 252L and arranged to interconnect middle segment 252M and third fold line F3 as suggested in FIG. 3.

Second pillar notch 152 is arranged to open toward second corner pillar 42 and a portion of floor support 40 is located in second pillar notch 152 so as to be visible to an observer looking into interior food-storage region 19 through top aperture 17 and arranged to define a boundary of interior food-storage region 19 formed in container 12 as suggested in FIG. 1. An upwardly facing surface of portion of floor support 40 that is located in second pillar notch 152 is arranged to lie in substantially coplanar relation to film layer 21 of susceptor 20.

Third pillar notch 153 is defined by a bell-shaped concave edge 153e as shown, for example, in FIG. 3. Bell-shaped concave edge 153e interconnects second end edge 303 and second side edge 304 and borders a bell-shaped second outer section 53o of first strip 401 of floor support 40 to expose an upwardly facing portion of bell-shaped second outer section 53o to any food extant in interior food-storage region 19 of container 12 as suggested in FIG. 1. Bell-shaped concave edge 153e includes a middle segment 253M arranged to face toward third corner pillar 43, a first (left) convex segment 253L bowed outwardly toward second side panel 34 and arranged to interconnect middle segment 253M and third fold line F3, and a second (right) convex segment 253R bowed outwardly toward first convex segment 253L and arranged to interconnect middle segment 253M and fourth fold line F4 as suggested in FIG. 3.

Third pillar notch 153 is arranged to open toward third corner pillar 43 and a portion of floor support 40 is located in third pillar notch 153 so as to be visible to an observer looking into interior food-storage region 19 through top aperture 17 and arranged to define a boundary of interior food-storage region 19 formed in container 12 as suggested in FIG. 1. An upwardly facing surface of the portion of floor support 40 that is located in third pillar notch 153 is arranged to lie in substantially coplanar relation to film layer 21 of susceptor 20.

Fourth pillar notch 154 is defined by a bell-shaped concave edge 154e as shown, for example, in FIG. 3. Bell-shaped concave edge 154e interconnects second side edge 304 and first end edge 301 and borders a bell-shaped second outer section 54o of second strip 402 of floor support 40 to expose an upwardly facing portion of bell-shaped second outer section 54o to any food extant in interior food-storage region 19 of container 12 as suggested in FIG. 1. Bell-shaped concave edge 154e includes a middle segment 254M arranged to face toward fourth corner pillar 44, a first (left) convex segment 254L bowed outwardly toward first end panel 31 and arranged to interconnect middle segment 254M and fourth fold line F4, and a second (right) convex segment 254R bowed outwardly toward first convex segment 254L and arranged to interconnect middle segment 254M and fold line F1 as suggested in FIG. 3.

Fourth pillar notch 154 is arranged to open toward fourth corner pillar 44 and a portion of floor support 40 is located in fourth pillar notch 154 so as to be visible to an observer looking into interior food-storage region 19 through top aperture 17 and arranged to define a boundary of interior food-storage region 19 formed in container 12 as suggested in FIGS. 3 and 4 when viewed together. An upwardly facing surface of the portion of floor support 40 that is located in fourth pillar notch 154 is arranged to lie in substantially coplanar relation to film layer of susceptor 20.

Rim 38 of framework 18 includes a first border segment 381 arranged to extend between first and second corner pillars 41, 42 and a relatively thinner top panel-mount flange 381f arranged to extend downwardly from first border segment 381 toward floor support 40 as suggested in FIG. 5. First side panel 32 is arranged to mate with the relatively thinner top panel-mount flange 381f and abut an exterior edge of first border segment 381 as suggested in FIGS. 1 and 5. First side panel 32 is also arranged to mate with a relatively thinner side panel-mount flange 411 included in one side of first corner pillar 41 and with a relatively thinner side panel-mount flange 422 included in one side of second corner pillar 42 as suggested in FIGS. 1 and 5.

Rim 38 of framework 18 includes a second border segment 382 arranged to extend between second and third corner pillars 42, 43 and a relatively thinner top panel-mount flange 382f arranged to extend downwardly from first border segment 381 toward floor support 40. Second end panel 33 is arranged to mate with the relatively thinner top panel-mount flange 382f and to abut an exterior edge of second border segment 382 as suggested in FIG. 1. Second end panel 33 is also arranged to mate with a relatively thinner panel-mount flange included in one side of second corner pillar 42 and with a relatively thinner side panel-mount flange included in one side of third corner pillar 43.

Rim 38 of framework 18 includes third border segment 383 arranged to extend between third and fourth corner pillars 43, 44 and a relatively thinner top panel-mount flange 383f arranged to extend downwardly from third border segment 383 toward floor support 40. Second side panel 34 is arranged to mate with the relatively thinner top panel-mount flange 383f and to abut an exterior edge of third border segment 383. Second side panel 34 is also arranged to mate with a relatively thinner panel-mount flange included in one side of third corner pillar 43 and with a relatively thinner side panel-mount flange included in one side of fourth corner pillar 44.

Firm 38 of framework 18 includes a fourth border segment 384 arranged to extend between fourth and first corner pillars 44, 41 and a relatively thinner top panel-mount flange 384f arranged to extend downwardly from fourth border segment 384 toward floor support 40 as suggested in FIG. 1. First end panel 31 is arranged to mate with the relatively thinner top panel-mount flange 384f and to abut an exterior edge of fourth border segment 384. First end panel 31 is also arranged to mate with a relatively thinner panel-mount flange 441 included in one side of fourth corner pillar 44 and a relatively thinner side panel-mount flange 412 included in one side of first corner pillar 41 as suggested in FIGS. 1, 2, and 3.

In illustrative embodiments, first corner pillar 41 includes a first center column 410 arranged to interconnect rim 38 and floor support 40 and a relatively thinner first side panel-mount flange 411 arranged to extend downwardly along one side of first center column 410 and laterally toward second corner pillar 42. Second corner pillar 42 includes a second center column 420 arranged to interconnect rim 38 and floor support 40 and a relatively thinner second side panel-mount flange 422 arranged to extend downwardly along one side of second center column 420 and laterally toward the first corner pillar 41 to lie in spaced-apart relation to the relatively thinner first side panel-mount flange 411 to form a first side opening 400 therebetween as suggested in FIG. 5. First side panel 32 is arranged to mate with each of the relatively thinner first and second side panel-mount flanges 411, 422 to span first side opening 400 and to abut an exterior edge of each of first and second center columns 410, 420 as suggested in FIGS. 1 and 5.

As suggested in FIG. 1, floor 30 and panels 31-34 of sheet 16 cooperate with portions of floor support 40 (e.g., exposed portions 51o, 52o, 53o, and 54o of strips 401, 402) and of corner pillars 41-44 to form a basin defining interior food-storage region 19 and depending from endless rim 38. As suggested in FIG. 5, strips 401, 402 of floor support 40 cooperate with corner pillars 41-44 to form a basket arranged to depend from endless rim 38. Sheet 16 is coupled to framework 18 to close the several openings formed in the basket as suggested in FIGS. 1 and 5.

Sheet 16 includes a floor 30 and an upstanding wall 300 coupled to the floor 30 as suggested in FIG. 1. It is within the scope of the present disclosure to use on or more panels to form upstanding wall 300 and panels 31-34 cooperate to form upstanding wall 300 in the illustrated embodiment. Framework 18 comprises an endless rim 38 and a floor support 40 coupled to the outer surface of a portion of paperboard heat-insulation shield 23 included in floor 30 of sheet 16. At least two pillars are arranged to lie in spaced-apart relation to one another and to interconnect endless rim 38 and floor support 40 and coupled to a portion of the outer surface of paperboard heat-insulation shield 23 included in the upstanding panels of sheet 16. Endless rim 38, at least two pillars, portions of floor support 40, and film layer 21 of susceptor 20 cooperate to form a basin defining interior food-storage region 19. It is within the scope of this disclosure to use any suitable number of pillars to support an upstanding wall of any selected shape.

Floor support 40 includes a first exposed portion 510 coupled to a first of the at least two pillars and positioned to lie in a first pillar notch 151 formed in sheet 16 to form a portion of the basin without lying under floor 30 of sheet 16. In an illustrative embodiment, basin has a generally rectangular shape, framework 18 includes four separate pillars 41, 42, 43, 44, and each pillar 41-44 is arranged to lie at one of four corners included in the basin. In other illustrative embodiments, the basin could have a round curved, oval, circular, hemispherical, or other suitable shape.

Susceptor 20 further includes a film layer 21 and metal layer 20 is interposed between paperboard heat-insulation shield 23 and film layer 21 and mated to film layer 21. Sheet 16 includes a floor 30 and an upstanding wall 300 coupled to floor 30 and arranged to cooperate with framework 18 to form a basin defining interior food-storage region 19. Framework 18 includes a rim 38 arranged to mate with upstanding wall 300 of sheet 16, a floor support 40 arranged to extend under and mate with floor 30 of sheet 16, and at least two pillars arranged to mate with upstanding wall 300 of sheet 16 and cooperate with sheet 16 to form the basin.

In illustrative embodiments, microwavable food package 10 comprises a framework 18 made of a plastics material and formed to include an endless rim 38 and a basket 40-44 arranged to depend from endless rim 38 and formed to include several openings. A sheet 16 that is coupled to framework 18 to close the several openings formed in the basket. Sheet 16 cooperates with framework 18 to form a container 12 having a basin defining an interior food-storage region 19. Sheet 16 comprises a susceptor 20 configured to provide means for absorbing electromagnetic energy generated in a microwave oven and converting it to heat that is applied to any food extant in interior food-storage region 19 and a paperboard heat-insulation shield 23 interposed between and coupled to framework 18 and susceptor 20 to establish a heat-insulation buffer between framework 18 and susceptor 20.

Sheet 16 includes a floor 30 and upstanding panels 31-34 coupled to floor 30 as shown, for example, in FIG. 3. Basket includes a floor support 40 coupled to a portion of paperboard heat-insulation shield 23 included in floor 30 of sheet 16 and at least three pillars. The pillars are arranged to interconnect endless rim 38 and floor support 40 to form the several openings therebetween and coupled to a portion of the outer surface of paperboard heat-insulation shield 23 included in upstanding panels 31-34 of sheet 16.

Floor support 40 includes a first strip 401 arranged to interconnect two of the at least three pillars and a second strip 402 coupled to a third of the at least three pillars and first strip 401. Paperboard heat-insulation shield 23 included in sheet 16 is coupled to endless rim 38, the at least three pillars, and first and second strips 401, 402 to close the several openings.

It is customary for convenience foods to be housed in microwavable paperboard cartons that are sold in outer paperboard boxes or wraps. In use, the box or wrap is removed and the user then places the microwavable paperboard carton in a microwave oven to cook the food stored in the carton.

In accordance with the present disclosure, microwavable food package 10 comprises a skeleton plastic structure with insert-molded panels made, for example, of paperboard that house susceptors. In an illustrative embodiment, the susceptors include thin layers of metal that, when placed in the vicinity of food, accelerate and define the cooking process of the food when exposed to microwaves in a microwave oven. A susceptor in accordance with the present disclosure is separated from the skeleton plastic structure by a heat-insulation material such as paperboard so that the plastic structure is not in direct and/or thermal contact with the susceptor so that the plastic structure does not soften and/or melt when the susceptor is heated in a microwave oven. A susceptor can reach a temperature of about 500° F. or more when heated in a microwave oven. Microwavable food package 10 is rigidified and provides a dual-purpose single container which functions to transport food from maker to seller to buyer and to hold food as it is cooked in a microwave oven.

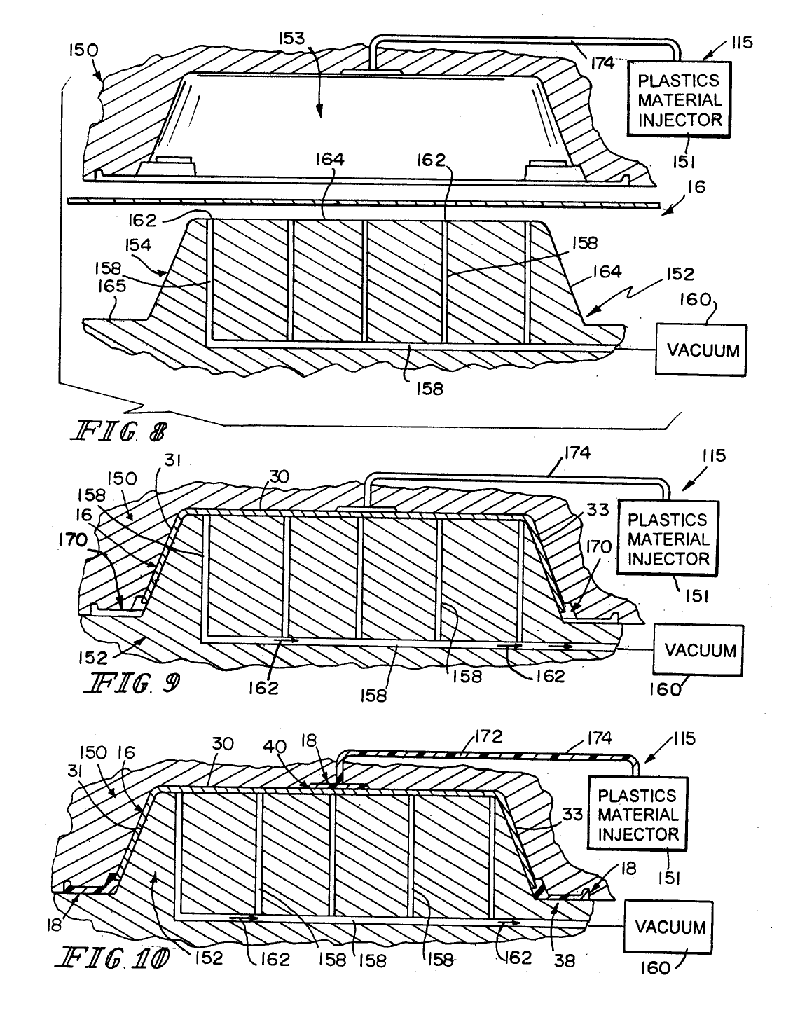

Microwavable food package 10 can be manufactured using the molding process of FIGS. 7-10. Package 10 is molded using plastics injection mold 115 as shown in FIGS. 8-10. Mold 115 includes an upper (female) mold portion 150 as shown, for example, in FIG. 8 and a lower (male) mold portion 152 shown, for example, in FIGS. 7 and 8. Upper and lower mold portions 150, 152 are movable between an opened position, as shown in FIG. 8, and a closed position, as shown in FIGS. 9 and 10. Illustratively, upper mold portion 150 is coupled to a plastics material injector 151 provided for injecting a suitable plastics material into upper mold portion 150 of mold 115 as suggested in FIG. 10.

Upper mold portion 150 is formed to include a downwardly opening cavity 153 that is sized to receive therein a sheet support 154 included in lower mold portion 152 as suggested in FIG. 8. In an illustrative embodiment, lower mold portion 152 includes a plate 156 underlying sheet support 154 and lower mold portion 152 is formed to include vacuum channels 158 coupled to a vacuum source 160 and arranged to communicate with apertures 162 formed in an outer surface 164 of shield support 154 as shown, for example, in FIGS. 7 and 8.

As suggested in FIGS. 7-9, sheet 16 is positioned to lie between upper and lower mold portions 150, 152 when mold portions 150, 152 are in the opened and closed positions. In one process suggested in FIG. 7, sheet 16 is folded, inverted, and placed on sheet support 154. In another process suggested in FIGS. 8 and 9, sheet 16 is deformed to fit onto outer surface 164 of sheet support 154 when the mold portions 150, 152 are moved to assume their closed positions.

In an illustrative embodiment, a vacuum 162 is applied to an underside of sheet 16 and retains sheet 16 in closely conforming relation to outer surface 164 of sheet support 154 and outer surface 165 of plate 156 as suggested in FIGS. 9 and 10.

In accordance with the process of the present disclosure, sheet 16 cooperates with upper and lower mold portions 150, 152 as suggested in FIG. 9 to form a mold cavity 170 sized and shaped to form framework 18 therein. Framework 18 is formed and fused to sheet 16 when liquid plastics material 172 is injected through conduit 174 into mold cavity 170 as suggested in FIG. 10.

Once liquid plastics material 172 cools, it assumes a solid form to produce framework 18. A mechanical bond is formed between framework 18 and sheet 16 to produce container 12. Container 12 is removed from mold 115, filled with food (not shown), and mated to closure 14 to produce microwavable food package 10. The result is that framework 18 is overmolded onto sheet 16 to form one continuous and homogenous container 12 without any additional assembling or manufacturing steps.

1. A microwavable food package comprising
a container formed to include an interior food-storage region and
a closure coupled to the container to close a top aperture opening into the interior food-storage region, wherein the container includes a sheet and a framework that cooperates with the sheet to form the interior food-storage region, the sheet comprises a heat-insulation shield and a susceptor coupled to the heat-insulation shield, the framework is made of a plastics material and is coupled to the heat-insulation shield without contacting the susceptor, the susceptor is configured to provide means for absorbing electromagnetic energy generated in a microwave oven and converting it to heat that is applied to any food extant in the interior food-storage region, and the heat-insulation shield is arranged to separate the susceptor from the framework.

2. The package of claim 1, wherein the heat-insulation shield includes an outer surface mating with framework and an inner surface facing away from the framework and toward the interior food-storage region and the susceptor comprises a film layer bounding a first portion of the interior food-storage region and a metal layer lying between and mating with each of the film layer and the inner surface of the heat-insulation shield to cause the heat-insulation shield to provide a heat-insulation buffer between the framework and the metal layer of the susceptor to minimize heat transfer between the framework and the metal layer when the metal layer is heated to assume a high temperature when exposed to electromagnetic energy.

3. The package of claim 2, wherein the sheet includes a floor, having, in series, a first end edge, a first side edge, a second end edge, and a second side edge, a first end panel coupled to the floor along a first fold line established at the first end edge and arranged to extend upwardly away from the floor, a first side panel coupled to the floor along a second fold line established at the first side edge and arranged to extend upwardly away from the floor, a second end panel coupled to the floor along a third fold line established at the second end edge and arranged to extend upwardly away from the floor to locate the interior food-storage region therebetween, and a second side panel coupled to the floor along a fourth fold line established at the second side edge and arranged to extend upwardly away from the floor to locate the interior food-storage region therebetween,

4. The package of claim 3, wherein the framework comprises a rim coupled to each of the first end panel, first side panel, second end panel, and second side panel, a floor support coupled to the floor, a first corner pillar interposed between and mated with the first end panel and the first side panel and arranged to interconnect the rim and the floor support, a second corner pillar interposed between and mated with the first side panel and the second end panel and arranged to interconnect the rim and the floor support, a third corner pillar interposed between and mated with the second end panel and the second side panel, and a fourth corner pillar interposed between and mated with the second side panel and the first end panel.

5. The package of claim 4, wherein the floor support includes a first strip arranged to interconnect the first and third corner pillars and a second strip coupled to the first strip at an intersection and arranged to interconnect the second and fourth corner pillars.

6. The package of claim 5, wherein the first strip includes a first inner section extending from the intersection toward the first corner pillar and first outer section interconnecting the first inner section and the first corner pillar, the first outer section is bell-shaped and has a width that widens progressively in a direction extending from the intersection toward the first corner pillar.

7. The package of claim 6, wherein the floor is formed to include a first pillar notch defined by a bell-shaped concave edge interconnecting the first end edge and the first side edge and bordering the bell-shaped first outer section of the first strip of the floor support to expose an upwardly facing portion of the bell-shaped first outer section to any food extant in the interior food-storage region formed in the container.

8. The package of claim 7, wherein the bell-shaped concave edge includes a middle segment arranged to face toward the first corner pillar, a first convex segment bowed outwardly toward the first side panel and arranged to interconnect the middle segment and the first fold line, and a second convex segment bowed outwardly toward the first convex segment and arranged to interconnect the middle segment and the second fold line.

9. The package of claim 4, wherein the floor is formed to include a first pillar notch interposed between the first end panel and the first side panel and arranged to open toward the first corner pillar and a portion of the floor support is located in the first pillar notch so as to be visible to an observer looking into the interior food-storage region through the top aperture and arranged to define a boundary of the interior food-storage region formed in the container.

10. The package of claim 9, wherein an upwardly facing surface of the portion of the floor support that is located in the first pillar notch is arranged to lie in substantially coplanar relation to the film layer of the susceptor.

11. The package of claim 4, wherein the rim includes a first border segment arranged to extend between the first and second corner pillars and a relatively thinner top panel-mount flange arranged to extend downwardly from the first border segment toward the floor support and the first side panel is arranged to mate with the relatively thinner top panel-mount flange and to abut an exterior edge of the first border segment.

12. The package of claim 11, wherein the first corner pillar includes a first center column arranged to interconnect the rim and the floor support and a relatively thinner first side panel-mount flange arranged to extend downwardly along one side of the first center column and laterally toward the second corner pillar, the second corner pillar includes a second center column arranged to interconnect the rim and the floor support and a relatively thinner second side panel-mount flange arranged to extend downwardly along one side of the second center column and laterally toward the first corner pillar to lie in spaced-apart relation to the relatively thinner first side panel-mount support to form a first side opening therebetween, and the first side panel is arranged to mate with each of the relatively thinner first and second side panel-mount flanges to span the first side opening and to abut an exterior edge of each of the first and second center columns.

13. The package of claim 3, wherein the floor is formed to include a first pillar notch defined by an edge interconnecting the first end edge and the first side edge, the framework includes a first corner pillar interposed between the first end panel and the first side panel and a floor support coupled to the first corner pillar and arranged to extend under the floor, and a first exposed portion of the floor support is positioned to lie in the first pillar notch and mate with the first corner pillar without lying under the floor of the sheet.

14. The package of claim 13, wherein the floor is formed to include a second pillar notch defined by an edge interconnecting the first side edge and the second end panel, the framework further includes a second corner pillar interposed between the first side panel and the second end panel, the floor support is coupled to the second corner pillar, and a second exposed portion of the floor support is positioned to lie in the second pillar notch and mate with the second corner pillar without lying under the floor of the sheet

15. The package of claim 2, wherein the sheet includes a floor and upstanding panels coupled to the floor and the framework comprises an endless rim, a floor support coupled to the outer surface of a portion of the heat-insulation shield included in the floor of the sheet, and at least two pillars arranged to lie in spaced-apart relation to one another and to interconnect the endless rim and the floor support and coupled to a portion of the outer surface of the heat-insulation shield included in the upstanding panels of the sheet, and wherein the endless rim, at least two pillars, portions of the floor support, and the film layer of the susceptor cooperate to form a basin defining the interior food-storage region.

16. The package of claim 15, wherein the floor support includes a first exposed portion coupled to a first of the at least two pillars and positioned to lie in a first pillar notch formed in the sheet to form a portion of the basin without lying under the floor of the sheet.

17. The package of claim 15, wherein the basin has a generally rectangular shape, the framework includes four separate pillars, and each pillar is arranged to lie at one of four corners included in the basin.

18. The package of claim 17, wherein the floor support includes a first strip arranged to interconnect a first and a third of the four separate pillars and extend under the floor of the sheet and a second strip coupled to the first strip at an intersecting point and arranged to interconnect a second and a fourth of the four separate pillars and extend under the floor of the sheet.

19. The package of claim 1, wherein the heat-insulation shield includes an outer surface mating with the framework and an inner surface facing away from the framework and toward the interior food-storage region and the susceptor comprises a metal layer mating with the inner surface of the heat-insulation shield to cause the heat-insulation shield to provide a heat-insulation buffer between the framework and the metal layer of the susceptor to minimize heat transfer between the framework and the metal layer when the metal layer is heated to assume a high temperature when exposed to electromagnetic energy.

20. The package of claim 19, wherein the heat-insulation shield is made of paperboard.

21. The package of claim 20, wherein the susceptor further includes a film layer and the metal layer is interposed between the heat-insulation shield and the film layer and mated to the film layer.

22. The package of claim 19, wherein the sheet includes a floor and an upstanding wall coupled to the floor and arranged to cooperate with the framework to form a basin defining the interior food-storage region.

23. The package of claim 22, wherein the framework includes a rim arranged to mate with the upstanding wall of the sheet, a floor support arranged to extend under and mate with the floor of the sheet, and at least two pillars arranged to mate with the upstanding wall of the sheet and cooperate with the sheet to form the basin.

24. A microwavable food package comprising
a framework made of a plastics material and formed to include an endless rim and a basket arranged to depend from the endless rim and formed to include several openings and
a sheet that is coupled to the framework to close the several openings formed in the basket and cooperate with the framework to form a container having a basin defining an interior food-storage region, wherein the sheet comprises a susceptor configured to provide means for absorbing electromagnetic energy generated in a microwave oven and converting it to heat that is applied to any food extant in the interior food-storage region and a heat-insulation shield interposed between and coupled to the framework and the susceptor to establish a heat-insulation buffer between the framework and the susceptor.

25. The package of claim 24, wherein the sheet includes a floor and upstanding panels coupled to the floor and the basket includes a floor support coupled to a portion of the heat-insulation shield included in the floor of the sheet and at least three pillars arranged to interconnect the endless rim and the floor support to form the several openings therebetween and coupled to a portion of the outer surface of the paperboard heat-insulation shield included in the upstanding panels of the sheet.

26. The package of claim 25, wherein the floor support includes a first strip arranged to interconnect two of the at least three pillars and a second strip coupled to a third of the at least three pillars and the first strip and the heat-insulation shield included in the sheet is coupled to the endless rim, the at least three pillars, and the first and second strips to close the several openings.

27. The package of claim 24, wherein the heat-insulation shield is made of paperboard.
